(19) United States
(12) Patent Application Publication
(10) Pub. No.: US 2011/0083950 A1
(43) Pub. Date: Apr. 14, 2011

(54) MULTI-DIRECTIONAL TACT SWITCH

(75) Inventors: YUSHO NAKASE, Yokohama (JP); LIANG SUN, Shenzhen (CN)

(73) Assignee: HON HAI PRECISION INDUSTRY CO., LTD., Tu-Cheng (TW)

(21) Appl. No.: 12/904,107

(22) Filed: Oct. 13, 2010

(30) Foreign Application Priority Data
Oct. 13, 2009 (CN) 200910308220.X

(51) Int. Cl. H01H 13/52

(52) U.S. Cl. 200/406

(57) ABSTRACT

A tact switch includes an insulative housing, a first conductive electrode, a second conductive electrode, an actuator and a metal cover. The insulative housing defines a receiving cavity which is provided with a fixed terminal and a movable terminal movably contacting with the fixed terminal. The first and second conductive electrodes are received in the receiving cavity. The second conductive electrode is located above and separated from the first conductive electrode. The actuator includes a ring portion defining a through hole at a center thereof, a press seat received in the through hole and defining a receiving groove and an elastic element received in the receiving groove. The metal cover is secured to the insulative housing and fixes the actuator in the insulative housing. When the ring portion is pushed by an exterior force, the elastic element drives the movable terminal to contact with the fixed terminal and a distance change between the first and second conductivity electrodes. And after the movable terminal can not further be moved, the distance between the first and second electrodes further change smaller due to own elasticity of the elastic element made from elastic material.

### BACKGROUND OF THE INVENTION

1. Field of the Invention

The present invention relates to a tact switch, and more particularly to a multi-directional tact switch electrically connecting with selected terminals via a multi-directional operation.

2. Description of the Related Art

U.S. Pat. No. 6,140,596 issued to Chin-Shan Tsay on Oct. 31, 2000 disclosed a conventional tact switch. The tact switch comprises a seat body, a first elastic element, a press set and a closure body. The press set that is disposed on the first elastic element comprises a hat body and a second elastic element. The second elastic element is made from an elastic plastic or rubber material. As soon as the press set is pressed down by an exterior force, the hat body will drive the second elastic element to in turn press the first elastic element. The rubber-made second elastic element of the press set will touch the first elastic element softly to maintain its best press-durability while the plastics-made hat body can keep its surface flush and smooth without wearing. But with the improvement of electrical arrangement in which the tact switch is used, the tact switch need more function to satisfy the trend.

In view of the above, a new tact switch that overcomes the above-mentioned disadvantages is desired.

### SUMMARY OF THE INVENTION

Accordingly, an object of the present invention is to provide a tact switch electrically connecting with selected terminals via a multi-directional operation.

To fulfill the above-mentioned object, a tact switch includes an insulative housing, a first conductive electrode, a second conductive electrode, an actuator and a metal cover. The insulative housing defines a receiving cavity which is provided with a fixed terminal and a movable terminal movably contacting with the fixed terminal. The first and second conductive electrodes are received in the receiving cavity. The second conductive electrode is located above and separated from the first conductive electrode. The actuator includes a ring portion defining a through hole at a center thereof, a press seat received in the through hole and defining a receiving groove and an elastic element received in the receiving groove. The metal cover is secured to the insulative housing and fixes the actuator in the insulative housing. When the ring portion is pushed by an exterior force, the elastic element drives the movable terminal to contact with the fixed terminal and a distance change between the first and second conductivity electrodes. And after the movable terminal can not further be moved, the distance between the first and second electrodes further change smaller due to own elasticity of the elastic element made from elastic material.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a tact switch of the present invention;

FIG. 2 is an exploded view of the tact switch of FIG. 1;

FIG. 3 is a perspective view of an insulative housing, a fixed terminal and a first conductivity electrode;

FIG. 4 is an exploded view of an actuator;

FIG. 5 is a cross sectional view of the tact switch taken along line 5-5 in FIG. 1;

FIG. 6 is a cross sectional view of the tact switch taken along line 6-6 in FIG. 1 when the tact switch is a free station without any exterior force exerted on the actuator;

FIG. 7 is a cross sectional view of the tact switch taken along line 6-6 in FIG. 1 when the actuator is pushed by an exterior force; and

FIG. 8 is a cross sectional view of the tact switch taken along line 6-6 in FIG. 1 when the actuator is further pushed by the exterior force after a movable terminal can not further moved.

### DETAILED DESCRIPTION OF THE PREFERRED EMBODIMENT OF THE INVENTION

Reference will now be made to the drawings to describe the present invention in detail.

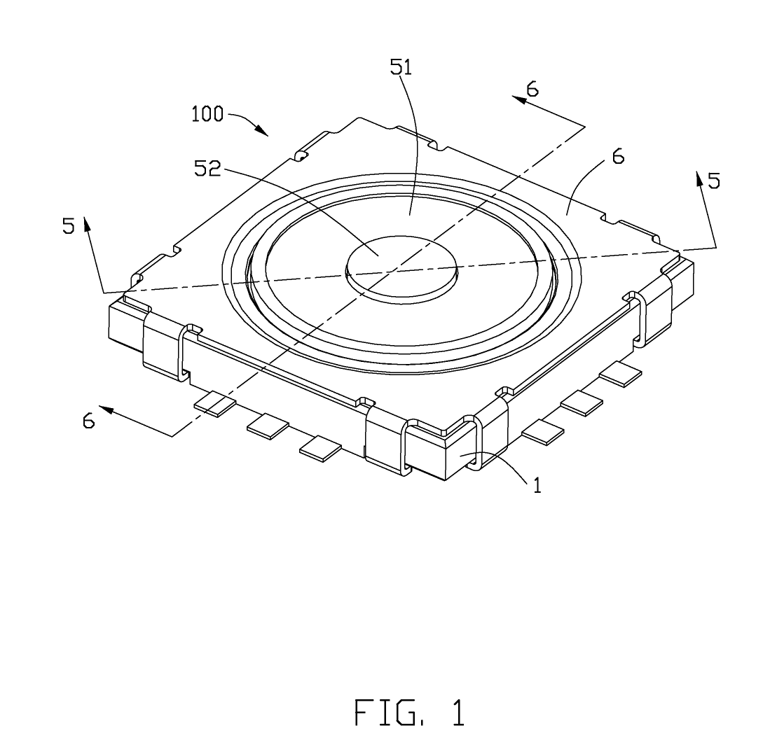

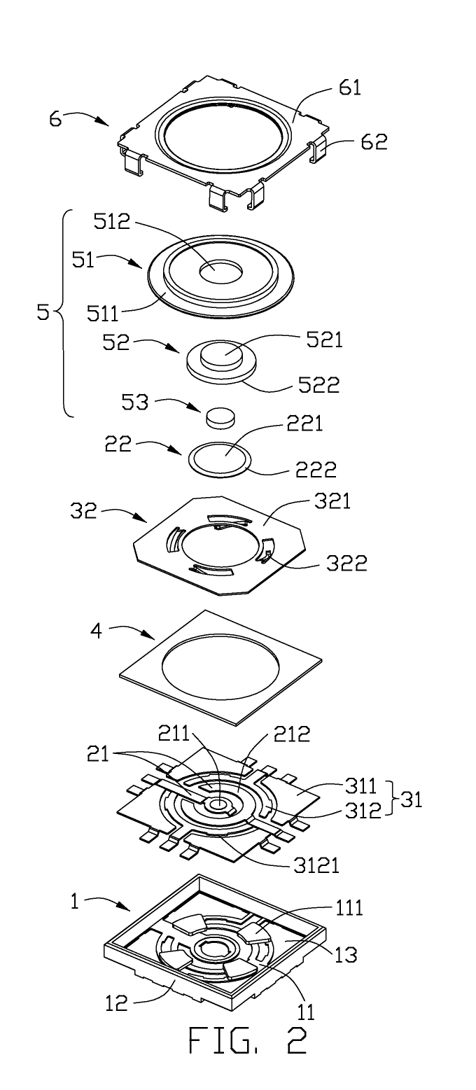

Referring to FIGS. 1-2, a tact switch 100 comprises an insulative housing 1, a fixed terminal 21, a movable terminal 22, a first conductivity electrode 31, a second conductivity electrode 32, a dielectric layer 4 between the first and second conductivity electrodes, an actuator 5 and a metal cover 6.

The insulative housing 1 is configured with a frame shape and comprises a bottom wall 11 and four side walls 12 extending upward from four side edges of the bottom wall 11. The bottom wall 11 and the side walls 12 define a receiving cavity 13 which is provided with the terminals and the electrodes. The insulative housing 1 further defines a plurality of stopper block 111 protruding out of the bottom wall 11. The stopper blocks 111 are separated from each other and each is configured with a fan shape.

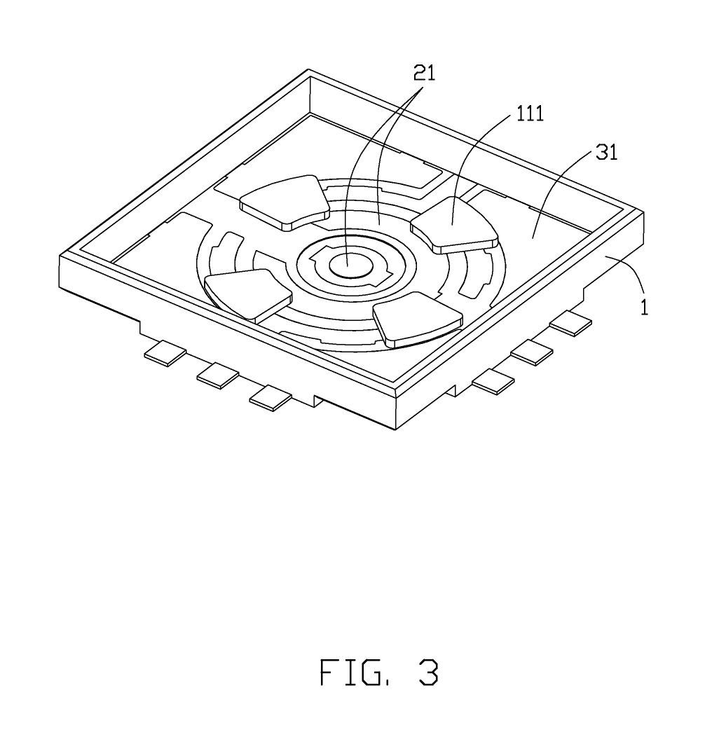

Referring to FIGS. 2-3, the fixed contact 21 comprises a first center contact portion 211 and a first periphery contact portion 212 around the center contact portion 211, both two are embedded in the bottom wall 11 of the insulative housing 1. The movable contact 22 is configured with a dome-like shape and comprises a second center contact portion 221 at a center thereof movably contacting with the first center contact portion 211 and a second periphery contact portion 222 around the second center contact portion 221 immovably contacting with the first periphery contact portion 212.

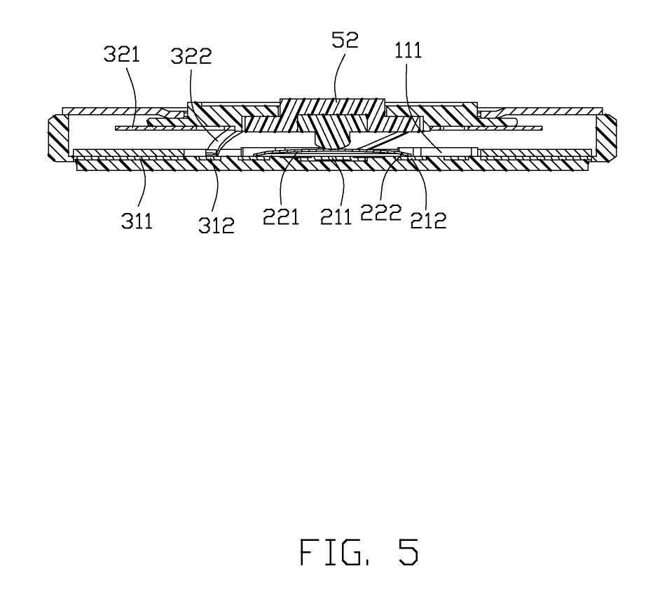

Referring to FIGS. 2 and 5, the first conductivity electrode 31 comprises four separate plate electrodes 311 located at four bending angles of the insulative housing 1 and a pair of ring electrodes 312 at inner sides of the plate electrodes 311. Each ring electrode 312 defines a pair of resisting points 3121 wider than the other structures thereof. The stopper blocks 111 are located at inner sides of the corresponding plate electrodes 311. The second conductivity electrode 32 comprises a plate portion 321 and four elastic legs 322 tearing from the plate portion 321 and resisting on the resisting points 3121. The plate portion 321 is parallel with the plate electrodes 311. The plate portion 321 and the plate electrodes 311 configure a capacity switch by changing a capacity therebetween. The dielectric layer 4 is located between the first and second conductivity electrodes 31, 32 to increase the capacity and make the capacity changing value evidence when a distance between the first and second conductivity electrodes 31, 32 is changed. The fixed terminal 21 and the first conductivity 31 are inserting-molded in the bottom wall 11 of the insulative housing 1 and respectively define soldering portions (not labeled) extending out of the insulative housing 1.

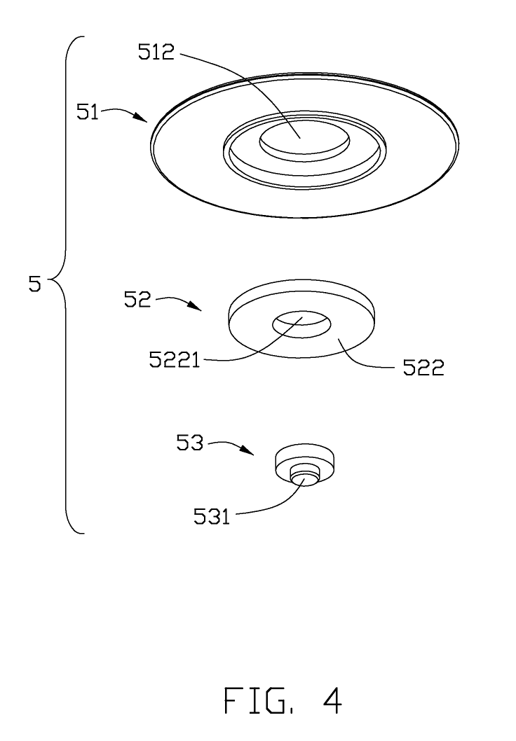

Referring to FIGS. 2 and 4, the actuator 5 comprises a ring portion 51, a press seat 52 and an elastic element 53. The ring portion 51 defines a through hole 512 at a center thereof. The press seat 52 is received in the through hole and defines a push face 521 and a contact face 522 exposing from two opposite sides of the through hole 512. The contact face 522 defines a receiving groove 5221 to receive the elastic element 53. The press seat 52 is made from plastic material and the elastic element 53 is made from an elastic material, e.g., rubber material. The plastic material can keep the push face 521 flush and smooth without wearing. The elastic material can maintain the elastic element press-durability.

The metal cover 6 comprises a main portion 61 and a plurality of hook portions 62. The metal cover 6 is located above the actuator 5 and secured to the insulative housing 1 by the hook portions 62 to fix all elements of the tact switch 100.

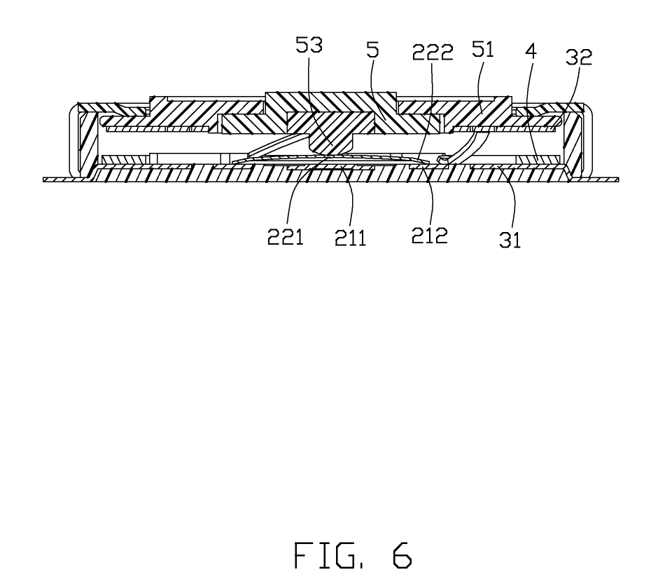

Referring to FIGS. 5 and 6 showing a free station of the tact switch 100 without any exterior force exerted on the actuator 5, the second periphery contacting point 222 contacts with the first periphery contacting point 212 and the second center contacting point 221 separates from the first center contacting point 211. The plate portion 321 of the second conductivity electrode 32 separates from the plate electrodes 311 with a predetermined distance while the elastic legs 322 are pressed against the ring electrode 312. The second conductivity electrode 32 is disposed under the bottom of the ring portion 51 and the dielectric layer 4 is located above the first conductivity electrode 31. The elastic element 53 resists on the second center contacting point 221.

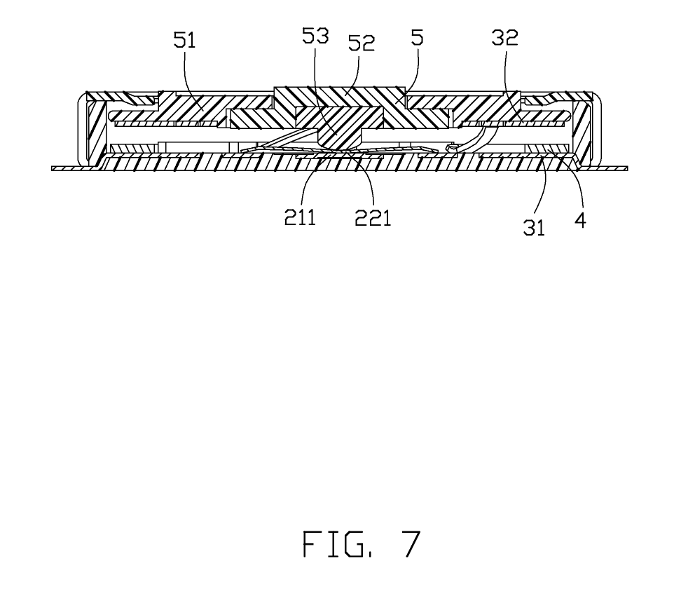

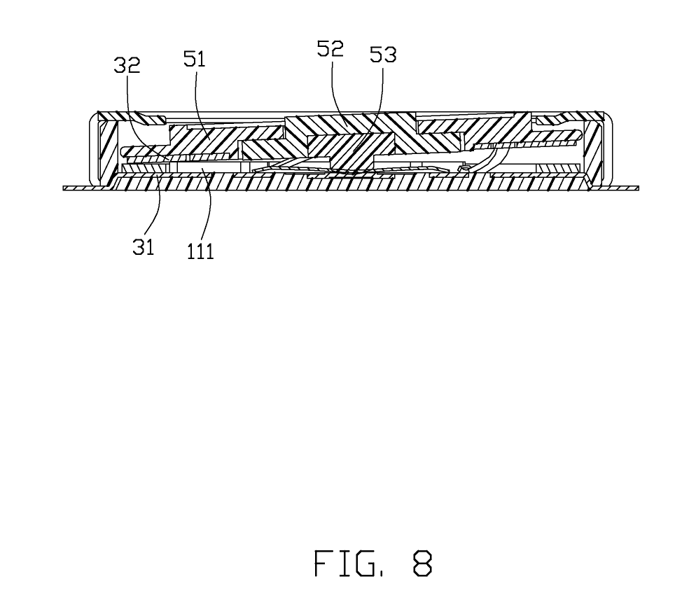

Referring to FIGS. 7 and 8 showing a work station of the tact switch with an exterior force exerted on the ring portion 51 and the actuator 5 shifts downwards as a whole, the second center contacting point 221 deforms downwards to contact with the first center contacting point 211 and the second conductivity electrode 32 is closer to the first conductivity electrode 31. Referring to FIG. 8, after the first and second center contacting points 211, 221 can not further moved, the second conductivity electrode 32 can move further downwards closer to the first conductivity electrode 31 since the elastic element 53 deforms itself until the second conductivity electrode 32 resists on the stopper blocks 111. That is to say, the invention can provide more distance change. The elasticity of the elastic element 53 prevents it from distorting the movable contact 22 and makes the change of the capacity quicker. The capacity switch works better along with the capacity changing quicker because the capacity switch is configured by the change of the capacity.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tact switch, comprising:
an insulative housing defining a receiving cavity which is provided with a fixed terminal and a movable terminal movably contacting with the fixed terminal;
a first conductive electrode and a second conductive electrode received in the receiving cavity, the second conductive electrode located above and separated from the first conductive electrode;
an actuator comprising a ring portion defining a through hole at a center thereof, a press seat received in the through hole and defining a receiving groove and an elastic element received in the receiving groove;
a metal cover secured to the insulative housing and fixing the actuator in the insulative housing; wherein
the elastic element drives the movable terminal to contact with the fixed terminal and a distance change between the first and second conductivity electrodes when the ring portion is pushed by an exterior force and the distance between the first and second electrodes further change smaller due to own elasticity of the elastic element made from elastic material after the movable terminal can not further be moved.

2. The tact switch as claimed in claim 1, wherein the insulative housing defines at least a stopper block, the distance between the first and second conductivity electrodes further change smaller until the second conductivity electrode resists on the stopper block.

3. The tact switch as claimed in claim 2, wherein the second conductivity electrode comprises a plate portion and a plurality of elastic legs tearing from the plate portion and resisting with the first electrode.

4. The tact switch as claimed in claim 3, wherein the first conductivity electrode comprises a ring electrode contacting with the elastic legs and four separate plate electrodes located at four bending angles of the insulative housing.

5. The tact switch as claimed in claim 4, wherein the first conductivity electrode is insert-molded in a bottom wall of the insulative housing.

6. The tact switch as claimed in claim 5, wherein tact switch further comprises a dielectric layer between the first and second conductivity electrodes.

7. The tact switch as claimed in claim 1, wherein the press seat is made from plastic material.

8. The tact switch as claimed in claim 1, wherein the first conductive electrode is located around and on the same plane with the fixed terminal.

9. A tact switch, comprising:
an insulative housing defining a receiving cavity;
a fixed terminal and a movable terminal received in the receiving cavity and movably contacting with the fixed terminal;
a first conductivity electrode and a second conductivity electrode received in the receiving cavity and spaced from each other with a predetermined distance;
an actuator with a elastic element resisting against the movable terminal and a ring portion resisting against the second conductivity electrode so as to drive the movable terminal to fixed terminal and the second conductivity electrode to the first conductivity electrode;
a cover covering on the insulative housing; wherein
the second conductivity electrode moves downwards to the first conductivity electrode with a greater distance than that of the movable terminal to the fixed terminal.

10. The tact switch as claimed in claim 9, wherein the insulative housing further defines a plurality of stopper blocks to support the second conductivity electrode when the cover move downwards

11. The tact switch as claimed in claim 10, wherein the first conductivity electrode comprises four separate plate electrodes movably contacting with the second conductivity electrode, the stopper blocks locating at inner sides of the corresponding plate electrodes.

12. The tact switch as claimed in claim 11, wherein each stopper block is configured with a fan shape.

13. The tact switch as claimed in claim 9, wherein the elastic element is made form elastic material.

14. A tact switch comprising:
an insulative housing defining a cavity;
a set of stationary terminals and a set of stationary electrodes disposed on the housing around a bottom region of the cavity;
a moveable terminal located above the set of stationary terminals;
a moveable electrode located above the set of stationary electrodes;
an actuator up-and-down moveable relative to the housing between upper and lower positions, and essentially aligned with moveable terminal in a vertical direction so as to urge the moveable terminal mechanically and electrically connected to the set of stationary terminals when said actuator moves to the lower position; and
said actuator being equipped with a resilient part, which is deformable in said vertical direction; wherein
said resilient part is deformed rapidly after the moveable terminal is mechanically and electrically connected to the set of stationary terminals so as to have the moveable electrode further moved relative to the set of stationary electrodes for prompting capacitance change.

15. The tact switch as claimed in claim 14, wherein the moveable electrode constantly mechanically an electrically connect to one of said set of stationary electrode.

16. The tact switch as claimed in claim 15, wherein said moveable electrode and said one of the stationary electrode are constantly mechanically and electrically connected via a resilient structure.

17. The tact switch as claimed in claim 14, wherein said actuator include s stiff press seat upwardly exposed to an exterior, and said resilient part is located under said press seat.

18. The tact switch as claimed in claim 17, wherein said actuator further includes a ring portion surrounding and downwardly pressing the press seat, and the moveable electrode is downwardly urged by said ring portion and the press seat is up and down moveable relative to the ring portion in the vertical direction.

19. The tact switch as claimed in claim 18, wherein the press seat is upwardly supported by the moveable terminal, and the ring portion is upwardly supported by the moveable electrode while optionally further upwardly supported by the press seat.

20. The tact switch as claimed in claim 14, wherein the housing forms a plurality of stopper blocks for preventing the moveable electrode from mechanically and electrically connected to others of said set of stationary electrodes.
